(19) United States
(12) Patent Application Publication
(10) Pub. No.: US 2015/0262307 A1
(43) Pub. Date: Sep. 17, 2015

(54) METHOD AND SYSTEM FOR CONSISTENT VALIDATION, TRACKING AND RETIREMENT GUIDANCE

(71) Applicant: P. CHRISTOPHER KRUEGER, Verona, WI (US)

(72) Inventor: P. CHRISTOPHER KRUEGER, Verona, WI (US)

(21) Appl. No.: 14/657,440

(22) Filed: Mar. 13, 2015

Related U.S. Application Data
(60) Provisional application No. 61/953,010, filed on Mar. 14, 2014.

(51) Int. Cl. G06Q 40/06

(52) U.S. Cl. CPC G06Q 40/06

(57) ABSTRACT

A computer system generally concerning systems, methods and apparatus related to financial management and reporting including a data storage device comprising participants, acceptable risk, accounts, financial vehicles, assets, income streams, funds, fiduciaries, sponsors, and administrators data and criteria, service items, notification, communication and history. The system is designed to receive information comprising participant data, including investment risk criteria, investment information, participant assets, anticipated income streams and produce multiple outputs dependent on factors comprising future applied criteria such as goal dates, inflation, expected contribution rates so as to assist in selection of appropriate financial vehicles for long-term retirement savings, document the available alternatives, participant information, risk attributes, information received and projections, facilitate required communications, educational opportunities and document users interactions and selections. The system is designed to facilitate compliance, document compliance and evaluate compliance with fiduciary duties and related matters.

### RELATED APPLICATIONS

This application is the non-provisional application of U.S. Provisional Application No. 61/953,010 filed Mar. 14, 2014, invented by P. Christopher Krueger, and upon which the present application relies for priority.

### 1. FIELD OF INVENTION

The present invention pertains to methods, systems and apparatus for consistent evaluation, reporting, and maintenance of multiple and various investment and financial vehicles for individual, employer and/or sponsor based retirement or set goal date assessment, guidance, education, validation, compliance and risk mitigation.

### 2. DESCRIPTION OF THE RELATED ART

Methods and systems for evaluation of Target Date Funds for individual investor consumers (participants/employees) are known (as described in U.S. Pat. No. 8,255,308, issued to Dial, Santiago, Browne, Trevisan, Avitable, Musto, and Mauck, Aug. 28, 2012). A Target Date Fund, also known as a lifecycle, dynamic-risk or age-based fund, is one with a declared end date (target date) or retirement date and which may change asset allocation according to the proximity to the declared end date or retirement date, with or without investor direction. Existing methods and systems for evaluation of Target Date Funds typically permit the evaluation of a single style of investment vehicle or fund based upon market conditions and assumptions over time.

Existing methods and systems for evaluation of Target Date Funds are used for individual investor consumers or multiple investor consumers including but not limited to the case where an employer acts as plan sponsor providing a Qualified Default Investment Alternative (“QDIA”). QDIA's are presently defined in 29 C.F.R. 2550.404c-5(e) (“Fiduciary relief for investments in qualified default investment alternatives”), as part of the Pension Protection Act of 2006, and are intended to encourage investment of employee assets in appropriate financial vehicles for long-term retirement savings. The intent of the language of the Pension Protection Act of 2006 is to ensure that acceptable QDIA investments are appropriate as a single investment capable of reaching an employee's retirement savings needs. A QDIA must be managed by an investment manager, plan trustee, plan sponsor, committee of employees of the plan sponsor, or a registered investment company. Determining to use a QDIA is not a fiduciary duty, but the optimal or close to optimal selection of the QDIA financial vehicle is a fiduciary act. The ability to maintain a record of selection of a QDIA for plan participants is also desirable.

Known methods and systems are not focused on mitigating risk in the ever increasing litigation and compliance environment and are not designed to provide the ability to document compliance with safe harbor provisions, adjust to changing safe harbor assumptions, capture contemporaneous financial environmental variables, document reasonable assumptions taken in execution of fiduciary duties or adequately record disclosure and notification. Known methods and systems also fail to adequately incorporate and track educational opportunities for employees or participants, facilitate consistent advice and guidance, maintain consistent advice and guidance, allow access to historical information and performance, permit efficient enrollment and employee plan termination, permit efficient notice and education, or permit the efficient review of status and projections.

Among the range of types of investors, one common type seeks to obtain sufficient funds (money) to retire from employment. Another type of investor may seek to obtain sufficient funds (money) to provide a lump sum or stream of funds (money) at a determined date, regardless of employment. These types of investors may be considered long-term investors, even while their term of investment may be limited. Similar long-term investors may be those participating in education savings plans, saving for life changes, purchases or other situations requiring relatively larger asset accumulation.

Long-term investors may voluntarily seek to place capital in the range of possibilities present in the investment and financial markets with guidance and/or services from investment entities such as financial advisors or other associations, unions or their employer. Other long-term investors may have their capital, or capital on their behalf, invested with guidance and/or services provided by their employers, unions, associations, by administrators of defined contribution plans, or by plan sponsors. Record keepers or other plan administrators may exist to assist in the documentation, communication and notification of information regarding long-term investors' capital or capital on their behalf invested with guidance and/or services of others such as employers, unions, associations, by administrators of defined contribution plans, or by plan sponsors.

Plan sponsors may also be considered those entities that establish and are responsible for the administration of a benefit plan with a fiduciary duty to those individual long-term investors or plan participants and beneficiaries (see e.g. 29 C.F.R. 2550 “Rules and Regulations for Fiduciary Responsibility”). A plan sponsor may directly be an employer, union, association, or such organization, in addition to a third party selected and designated by an employer, union, association or such organization. Administrators of defined contribution plans may also directly be an employer, union, association, or such organization, in addition to a third party selected and designated by an employer, union, association or such organization, and such administrators of defined contribution plans have a fiduciary duty to those individual long-term investors or plan participants and beneficiaries. Employers or others such as a union, association, or such organization sponsoring qualified benefit plans, including 401(k) plans, defined benefit plans, employee stock ownership plans and 403(b) plans also may be considered plan sponsors, among others.

Individual long-term investors or plan participants may actively participate in and manage their investments with guidance and/or service or they may chose not to or be unable to actively manage their investments. In certain cases, plan sponsors may provide a Qualified Default Investment Alternative (“QDIA”). QDIA's are presently defined in 29 C.F.R. 2550.404c-5(e). This section of the Code (29 C.F.R. 2550.404c-5) also provides limited fiduciary duty relief under certain conditions and has been referred to as “safe harbor”. Whether safe harbor is established legislatively, judicially or is anticipated, certain conditions and/or best practices for fiduciaries for QDIA, defined contribution plans, or other similar situations should be practiced and documented in order to afford the relief which may exist. Mitigation of fiduciary risk is often a goal of plan sponsors and administrators. The specific method or means of achieving the conditions and/or best practices, surrounded by the then existing financial, political and investment environment, must be reasonable and documented in order claim the greatest benefit of safe harbor.

Fiduciary duties found in use of a QDIA or other automatic enrollment plans may go far beyond the fiduciary duty to select and monitor the default investments for automatic participant contributions. Among the many duties, fiduciaries are in a position of trust and are required to act solely in the interest of the participants and their beneficiaries; provide benefits to the participants and their beneficiaries; defray reasonable expenses; carry out duties with care, skill, prudence and diligence of a prudent fiduciary; follow plan documents; and to diversify plan investments to achieve the stated goals of the plan. Fiduciaries are required to timely remit contributions to the plan and regularly communicate with participants regarding their account balance, investment selection, and fees, among other items. Specific documentation of the process for investment selection, monitoring and decision making are also fiduciary responsibilities. The selection and monitoring of the QDIA is also a fiduciary duty. Fiduciary best practices can include documented plan oversight committees, a formal written investment policy statement and compliance with the investment policy statement in selection and monitoring of activities.

If a third party is selected to perform fiduciary functions, the selection and monitoring of the third party is itself a non-delegable fiduciary act. Documenting this process, among others, will assist in risk mitigation. Seeking multiple third party fiduciaries, initially and continuing to evaluate their compensation, performance, reports, fees, policies and practices are steps to take with a third party fiduciary. If participants have complaints regarding the third party fiduciary, this too is a role and duty of the plan sponsor. Considerations may also include the affiliations, financial condition, experience, assets, business practices, qualities of the individual professionals employed by the third party fiduciary, insurance, past performance, and litigation or enforcement actions are all relevant inquiries in selection of a third party fiduciary.

As one example of fiduciary relief, limited fiduciary duty relief may be provided regarding the act of individual long-term investors or plan participants assets being placed in a specific QDIA, as long as certain opportunity, notice, information and ability to select among a broad range of investment alternatives criteria are met. There is no relief from the fiduciary duty of selecting and monitoring a QDIA. Additional fiduciary duties may exist for plan sponsor and/or administrators which are not yet well defined or gained acceptance at present.

Notice to the participants of a QDIA or other automatic enrollment plans such as a 401(k) may include an automatic enrollment notice detaining the plan, enrollment process and participant rights provided within the proper time period prior to eligibility to participate in the plan or the first investment. Annual notice may be also required prior to the beginning of the subsequent plan year. A summary plan description should be provided, identifying, among other things, the rights and responsibilities of the participants in the plan, features and expectations of the plan, eligible enrollment, contributions, vesting, when individuals are able to receive their benefits, how a claim for benefits is executed, what administrative expenses exist, and what rights and responsibilities participants have under the Employee Retirement Income Security Act. For example, when changes to the plan occur, participants should be provided a summary of material modification apprising them of changes made to the plan; each year a summary annual report, filed with the government, should be provided to participants; and each participant should also receive an individual benefit statement indicating the total plan benefits earned, vested benefits, fees, expenses, and the value of individual investment values on a timely basis. Notice to participants may be supplemented with educational opportunities which further explain, educate, develop and provide insight to individual or group participants, with one goal of many being reduction in risk for fiduciaries.

Similarly, administrators of defined contribution plans are required, among other things, to provide periodic pension benefit statements to participants and certain beneficiaries. These statements may contain different lifetime income illustrations and projections, in addition to the total benefits accrued. Reporting lifetime income illustrations and projections may include the use of various assumptions which if consistent with certain rules, may provide safe harbor in situations where actual assets do not meet past individual lifetime income illustration.

Best practices suggest that plan sponsors or administrators routinely evaluate plan participants and individual participants' retirement readiness or likelihood of achieving stated goals. A gap can occur between the stated participant goal or minimally defined retirement readiness and current projections of estimated accrued balance or estimated stream of payments. The contribution rate and a gap analysis can be documented and disclosed to participants showing existing and suggested contribution rates, the effect of variable assumptions, and the different levels of retirement readiness, or likelihood of achieving stated goals. Educational opportunities, based on such readiness, assumptions as well as contribution rates among others would also assist individual participants or groups of participants, with one goal among many being reduction in risk for fiduciaries. Similarly, the contribution rate, educational opportunities and a gap analysis can be documented and disclosed to plan sponsors or administrators, in exercise of their fiduciary duties, showing existing and suggested contribution rates, the effect of variable assumptions, and the different levels of retirement readiness, or likelihood of achieving stated goals. Documentation of such would also assist in reduction of risk to fiduciaries.

Evaluation of projected estimates of lifetime stream of payments and accrued balance, in addition to current account balance, can assist both plan participants and fiduciaries in meeting their obligations. The initial and ongoing collection of data regarding individual participants' circumstances, such as anticipated social security funds, additional assets, property, investments, and debts, along with participants' goals provide a more accurate picture of the plan participants and individual participants' retirement readiness, or likelihood of achieving stated goals. Identification, notice and the ability for adjustments to certain assumptions in projecting an estimated lifetime stream of payments and/or certain date estimated accrued balance, such as at the date of retirement, can also assist both plan participants and fiduciaries in meeting their obligations. For example, certain projections may include investment strategies that use a certain retirement date or those strategies that anticipate investing after retirement. The asset allocation within the investments made may also shift over time and be adjusted according to a retirement date, goal date, or according to a participant's individual risk tolerance or stated investment goals and choices, for example.

Asset allocation and the changes over time where investments are placed into a Target Date Fund is often referred to a glide path. Such a glide path also has criteria, assumptions and variables which should be identified and conveyed to participants and factored into assisting both plan participants and fiduciaries in meeting their obligations and to provide an accurate picture of groups of participants and individual participants' retirement readiness, or likelihood of achieving stated goals. Educational opportunities may be provided which further explain, educate, develop and provide insight to individual or group participants, with one goal of many being reduction in risk for fiduciaries may assist in asset allocation, glide path, criteria, assumptions, variables and readiness.

Numerous criteria, assumptions and variables should be identified in reaching an estimated account balance or stream of income, made known, and be able to be adjusted based upon individual, financial, political and market conditions. These criteria, assumptions and variables should also be able to be adjusted based on improvements in data and estimates over time, safe harbor compliance and other needs. For example, the level of inflation over time, anticipated social security funds, whether contribution levels remain constant or are assumed to increase at a regular rate, the retirement or goal date, current participant age, age at retirement or goal date, rate of investment return, draw down rate in fixed dollars or percent after the retirement or goal date or other method of payment, the mortality period and basis for computation including a participant, beneficiary and spouse, are all factors, among others, to identify, disclose and document as reasonable or compliant with regulatory or other safe harbor provisions. Educational opportunities and educational tools will assist in participants, users, sponsors, administrators comprehension and facilitate the purpose of disclosure and notifications of changes so that users understanding of the factors is improved resulting in risk mitigation to fiduciaries, as well as other possible liable parties.

Documenting the process and contemporaneous projections and variable assumptions will not only provide documentation but also permit different financial professionals to learn of the past process and performance decisions and provide an opportunity for guidance incorporating such history facilitating consistent advice as to meet current and future fiduciary obligations. More robust quantitative analysis, as well as historical information, can provide more consistent foundation for forward looking analysis among financial professionals in assisting plan sponsors and administrators.

Existing methods and systems are limited in multiple areas, for example in scope of the investment vehicles evaluated, attempt to operate with limited participant information, fail to provide consistent guidance among multiple advisors, and fail to consider whether participants will achieve their stated goals. Existing methods also fail to seamlessly integrate education and comprehension opportunities for participants and users, to facilitate comprehension, provide meaningful substance and comprehension of stated assumptions, changes and notices, and provide for risk mitigation, among other goals. Existing methods and systems may also fail to document participant data, participant declared risk tolerance, selection of investment vehicles or permit real time performance or automated record retention for participant initiated events, such as initial employment, inquiries to the plan administrator or employer, or employee termination, either initially or as they change over time. Existing methods and systems may also fail to document contemporaneous market, financial and political conditions, the numerous criteria, assumptions and variables identified in reaching an estimated account balance or stream of income, the routine evaluation of plan participants and individual participants' retirement readiness, or likelihood of achieving stated goals, and inquiry of participants, sponsors and administrators compliance with service items, notifications or documentation of fiduciary decision processes to mitigate risk.

### 3. SUMMARY OF THE INVENTION

The object of the present invention is to address the above mentioned problems and drawbacks. The present invention, which in some instances may be referred to as Standard of (K)are, has numerous benefits and advantages. The invention is designed with goals of risk mitigation, education, achieved through multiple methods. The invention is also designed with a goal of affording improved and consistent financial service and guidance among professionals and over time, achieved through multiple methods. The invention incorporates far more criteria than existing tools, providing a more detailed and accurate picture of the plan participants and individual participants' retirement readiness, or likelihood of achieving stated goals. In some aspects of the invention the participants' retirement readiness or likelihood of achieving stated goals may be identified as a SOK or SO(K) rating. In some aspects of the invention the level of use of the invention and compliance with fiduciary tools and documentation may be identified as a SOK or SO(K) rating. The collection of data and assessment of readiness provides for educational opportunities for improving workforce or participant comprehension, improvement in reducing fiduciary risk and risks to plan sponsors, among others, and facilitates employers understanding of workforce needs and may assist in anticipating future developments, which may also suggest implementation of additional education opportunities or alterations. The invention is designed to provide and support customized education plans with the ability to quantify results of such education. The invention is designed to provide a higher level of individualized service for individual participants and sponsors, with high visibility of results and demonstration of the value of services. The invention is also designed to provide increased efficiencies in data review, performance analysis, historical information, interaction among advisor, employee and/or sponsor. The invention also is not limited to the analysis or selection of Target Date Funds, although they may be analyzed by this invention.

According to embodiments of the present invention, a computer may receive information regarding employees or participants. Information about the individual employees or participants may comprise information such as age, anticipated retirement date or goal target date, risk tolerance based upon a risk tolerance evaluation or risk tolerance calculator. Information regarding employees or participants may also comprise participants' assets, obligations, anticipated needs and financial goals or objectives. Employees' or participants' financial goals and objectives may comprise an accrued balance figure or lifetime stream figure or be determined by a minimally defined retirement readiness level. An anticipated age at retirement or goal target date may be determined from the information received or explicitly set. Anticipated assets at retirement or goal target date, such as social security funds, may also be determined from received information or explicitly set. The mortality, draw down rate or amount, in consideration of the employee or participant, spouse or beneficiary, may also be determined from received information or explicitly set. The level of inflation to factor in, as well as contributions over time may also be determined from received information in conjunction with reasonable and agreed upon standard practices or explicitly set.

In some aspects of the invention educational opportunities will be generated based upon individual participants or groups of participants readiness, requested selections, accompanying notices, or upon direct selection by advisors, plan sponsors, administrators or other users. Educational opportunities, in some aspects of the invention, may be generated by data collected from participants, third-party data, changes in external factors which may alter assumptions, goal dates or factors. In some aspects of the invention, the educational opportunities, whose which were selected, those educational opportunities which were attended or participated in may also be collected and stored for later use, including that for output as needed in support of risk mitigation and historical review of information presented so as to assist fiduciaries and other potentially liable parties in risk mitigation. Educational tools, in some aspects of the invention, may also assist employers, plan sponsors or other groups to better understand the characteristics of individual or groups of participants, so as to improve understanding of anticipated needs, changes and developments affecting participants and the workplace. In some aspects of the invention, customized education plans are provided and supported with measurable results of such education. Measurable educational results may be provided to plan sponsors which may comprise indications of the value of the education, the value of the invention, the value of the advisor, and the status and change in retirement readiness or goal achievement over time, in some aspects of the invention. Retirement readiness or goal achievement may be presented in a Retirement Readiness Score, in some aspects of the invention.

Past investment and financial vehicle, comprising a QDIA, fund or pension performance may also comprise information received by the computer and in conjunction with other data received from the employee or participant or determined based upon information, the projected performance of the investment and financial vehicle at the retirement date or target goal date may be summarized and output for review by the user. The projected performance of other assets, comprising social security funds, home value, and additional investments for example, at the retirement date or target goal date may also be summarized and output for review by the user. The summary may be numerically and/or graphically displayed, and may comprise projected performance of the investment and financial vehicle, comprising a QDIA, fund or pension, as well as other assets, comprising social security funds, home value, and additional investments for example, at the retirement date or target goal date, as well as factors or variables used in determination of the projection summary.

In some aspects of the invention multiple summaries can be provided for review, displaying the result of changes in individual portions of the summary components comprising pension performance, social security funds, home value. In some aspects of the invention, summaries may be comprised of present status, current projections and projections based upon the result of changes in individual portions of the summary components in the same numerical and/or graphical display. In some aspects of the invention, numerous investment and financial vehicles, based on specific plans, comprising a QDIA, model portfolio, fund or pension, can be presented in summary or graphical form. A comparison may be used in selecting an optimal financial vehicle to attempt to reach the minimally defined retirement readiness level or participant's stated financial goal. Model portfolios may be used according to participant's risk tolerance, retirement data and asset allocation.

Documentation and collection of the summaries, projections, explicitly set figures, determined values, individual portions of the summary components will assist in mitigating risk, identify participant's individual selections, options and selections available to plan participants, document different projections and information presented to participants. Documentation and collection of educational opportunities, selected, offered, attended or participated in may also be collected and stored for later use, including that for output as needed in support of risk mitigation and historical review of information presented so as to assist fiduciaries and other potentially liable parties in risk mitigation. Documentation and collection will also assist in historical review of participant and sponsor changes over time, as well as permitting employers, sponsors and fiduciaries, among others, to anticipate future changes or needs and assist in shaping outcomes. Documentation and collection will also assist in the opportunity for consistent financial advisory assistance among individual advisors and over time, based upon quantitative data, historical criteria and selection patterns. Such documentation is expected to assist in participants understanding their retirement readiness or goal achievement, in addition to achieving greater rates of retirement readiness or goal achievement by use of the educational, reporting and feedback, among others, identified herein. Such documentation and collection is also expected to result in increased levels of customer service and higher efficiencies and profits. The documentation and collection may also be utilized in demonstration and visual representations of the value of services to customers, employees, participants, sponsors and employers. Generally, process based upon data collected and analyzed is expected to provide for improved performance and results. In some aspects of the invention, grouped participants' retirement readiness or likelihood of achieving stated goals may be output and identified as SOK or SO(K) results.

In some aspects of the invention, numerous participant's data would be collected and output for review by a user, such as a plan sponsor. This output could be presented for comparison in summary or graphical form permitting evaluation of numerous participant's data simultaneously so as assist in determining whether the selection of an investment vehicle, comprising a QDIA, is capable of reaching a group of employees or participants retirement savings needs specific to the participants risk tolerance. Documentation of risk tolerance, retirement readiness, goal achievement, education, alternative paths of financial contributions, opportunity for modification of other factors or assumptions may be collected, stored or presented in individual or group output. In some aspects of the invention multiple summaries can be provided for review, displaying the result of changes in individual portions of the summary components comprising investment vehicle performance and participant's or employees social security funds. In some aspects of the invention, summaries may provide current projections and projections based upon the result of changes in individual portions of the summary components in the same numerical and/or graphical display, for comparison. Documentation and collection of the summaries, projections, individual portions of the summary components will assist in mitigating risk, identify participant's individual selections, options and selections available to plan participants, options and selections available to plan sponsors, investment manager, plan trustee, plan sponsor, committee of employees of the plan sponsor, or a registered investment company, document different projections and information presented. In some aspects of the invention, data collected will suggest proposed deferral amounts, educational opportunities and personal histories to participants or employees among other items. In some aspects of the invention, data will suggest changes or anticipated employer or sponsor changes to deal with anticipated workforce or participant issues presenting in the invention data. In some aspects of the invention, a participant tracking log may be generated based upon individual participant's actions with the invention, and as may also be supplemented by others interactions with the invention. The invention may also provide access to, interact with, or output information to a customer relationship management system, in some aspects of the invention, as is known in the art. Documentation and collection will also assist in presenting consistent financial advisory assistance among individual advisors and over time, based upon quantitative data, historical criteria and selection patterns. In yet other aspects of the invention, automatic enrollment in default or standard investment options are facilitated.

In some aspects of the invention, data is stored contemporaneously so as to collect and provide relevant output. Individual participants, plan sponsors, employers, fiduciaries, administrators, mutual fund companies, investment management firms, and advisors may also be presented with numerous financial, output display and data analysis options, in some aspects of the invention. Output to mutual fund companies may comprise the amount of funds invested according to the advisor, which may comprise resulting additional performance, economies of scale, leverage among advisors with mutual fund companies, among other aspects of the invention. Output of contemporaneous and expected future performance is presented to individual participants, plan sponsors, employers, fiduciaries, administrators, and advisors, in some aspects of the invention, as well as the ability for real time or other than real time changes to numerous figures, financial, output display and data analysis options, with instant or other than instant evaluation and modified output of expected future performance, for example, in some aspects of the invention. Collection, documentation, and identification of the individual participants, plan sponsors, employers, fiduciaries, administrators, and advisors notes, choices, explicit selections, explicit figures, available options, suggestions, determined values, opportunities, educational programs, and other information will also be an element in some aspects of the invention, with the ability to recall such data over time. In some aspects of the invention, investment committee minutes as well as other fiduciary documents and documentation may be collected and stored. In some aspects of the invention, automated processes for automatic enrollment of employees and documentation of service items, notifications and determinations, collection and documentation of investment committee minutes and determinations, are also anticipated to improve risk mitigation.

Collection of and evaluation of fee structures for both contemporaneous and historical evaluation of financial vehicles is present in some aspects of the invention. Such evaluation may also be considered by and reviewed as output in individual participant and in groups of participant levels, such as by plan sponsors or fiduciaries. Administrative support, client interaction, participant and/or employer guidance via telephone, facsimile, email, online chat, videoconferencing or other such technologies in addition to personal visits are apparent in any customization, use and continued development of the invention. In some aspects of the invention, privacy controls and/or security settings will be automatically set or individually customized by client, participant, administrator, sponsor, employer or the like, so as to permit a range of access necessary for the invention to function and advice, guidance and fiduciary duties to be exercised. Customization, based upon participant data and participant input, may be documented in some aspects of the invention, with customization providing a goal of increased retirement readiness or goal achievement and/or decreased fiduciary, sponsor, advisor risk and/or liability.

Licensing of the invention, for example to employers and/or administrators, will also be present in some aspects of the invention, so as to facilitate guidance, educational opportunities, maintenance and improvement of the invention, ease of use and data exchange, for example.

These and other features of the invention will become apparent upon a more detailed description of preferred embodiments of the invention as described below. Other numerous benefits, advantages and embodiments will be apparent to those skilled in the art after consideration of the specification and practice of the invention. The specification and examples should be considered exemplary only. The platform for operation or output of the invention is not restricted to any one type of device or hardware and may have multiple such varied devices and hardware.

### 4. BRIEF DESCRIPTION OF THE DRAWING

These and other features, objects and advantages of the invention will be more fully appreciated with reference to the accompanying figure.

FIG. 1 presents a macro-level diagram of the Standard of (K)are invention illustrating the broad data and documentation instrument, based upon employee, sponsor, and/or advisor information, from new employee hire (or participant initiation) through employee retirement or termination (or participant conclusion); providing assessment, documentation, projection, data collection, data storage, reporting, service items, notification, real time and interval output of performance, collection of alternative selection, and output of risk mitigation performance, enabling education, facilitation of consistent guidance, all according to various embodiments of the present invention;

FIG. 2 illustrates an exemplary version of the output dashboard, according to various embodiments of the invention, permitting the summary display of numerous output options comprising summaries of plan costs, participant statistics, service calendar, fund watchlist, market value, provider benchmark, outbound results, plan design statistics, retirement readiness, goal achievement progress, educational opportunities taken or refused, additional participant data required, SOK or SO(K) results among others.

FIG. 3 illustrates an exemplary version of the presentation of visual display of participant age and age runout of retirement savings, according to various embodiments of the invention, permitting the summary display of a single or groups of participants' retirement readiness.

### 5. DESCRIPTION OF THE PREFERRED EMBODIMENT

Embodiments of the present invention are directed to methods, systems, and apparatus for consistent evaluation, reporting, education and maintenance of investment and financial vehicles for individual and groups of individuals, plan sponsors with retirement or goal date assessment, guidance, education, validation, compliance and risk mitigation.

Additional advantages and features of the invention, as well as operation and design of illustrative embodiments of the invention are described below. Further embodiments will be apparent to persons skilled in the relevant art(s) based on the teachings herein. Other embodiments are possible and alterations can be made to the illustrated embodiments within the spirit and scope of the invention. Any actual programming code to implement the present invention is not limiting of the invention. It would also be apparent to persons skilled in the relevant art(s) that the present invention can be implemented in different embodiments of the elements identified in the figures, software, computer instruction, firmware, and/or hardware. Instructions for performing a particular task may be characterized as a program, guide, check list, manual, software program, software, engine, module, component, mechanism, tool, or the like as those skilled in the art will appreciate. The embodiments and detailed description are not meant to limit the invention.

The elements identified in the figure are not necessarily rigidly defined, such that elements may overlap hardware and/or software components in functionality. It would be apparent to persons skilled in the relevant art(s) that the functionality of the elements in the figure may be defined in accordance with a number of stylistic or performance-optimizing techniques, for example. Reference to elements identified in the figure, specification and/or claims may be any combination of hardware or software components for performing the indicated function.

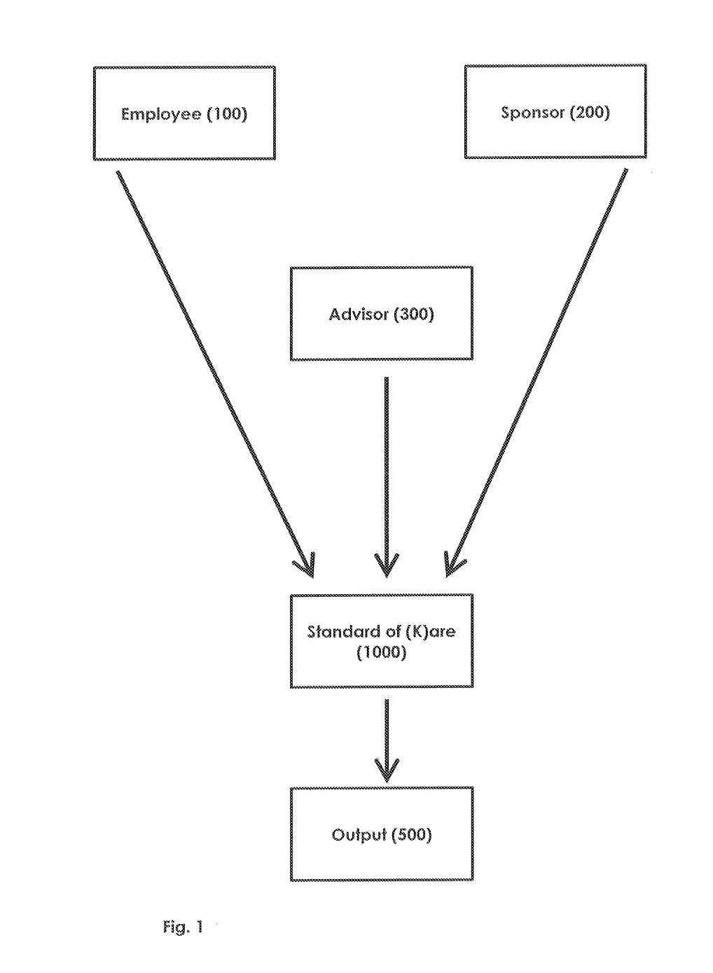

FIG. 1 illustrates a system of evaluating participant and group performance, maintaining documentation and collection of selections among alternatives and facilitating notice and educational information to users of the invention, in accordance with embodiments of the invention. The elements of FIG. 1 may include instructions executed on a computer, or as those skilled in the art will appreciate, various computers, computer devices, hand-held devices, wireless devices, mobile phones, personal digital assistants, lap-top computers, smart phones, servers, desktop computers, multiprocessor systems, microprocessor-based or programmable consumer electronics, minicomputers, mainframe computers, and the like, as well as practiced in distributed computing environments where individual tasks may be performed remotely and linked by way of a communications network.

Data may also be held locally, by removable/non-removable, volatile/nonvolatile computer storage media, or remotely and may be accessed by way of communications networks. Networks for practicing various embodiments of the invention may include wired or wireless local area network (LAN), a wide area network (WAN), wireless personal area network (PAN), and the like. Computers, instructions and/or data may be connected to one another over the Internet, an Intranet, Extranet, Ethernet, or the like, in both wired or wireless environments. As those skilled in the art will appreciate, numerous communications protocols may be used. Encryption and decryption of data, software, computer instruction, hardware, output and communication may also be utilized, as those skilled in the art will appreciate.

The Standard of (K) are element 1000 may be connected to a wireless or wired network for input, data storage, processing, and output. Data may also be stored locally. Data may be input by way of individual entry, group entry, limited access, collected from third-party sources and maintained automatically or at known intervals. The element 1000 may include data input by way of manual entry, communication with other data sources, or extrapolation based upon known available data. Manual entry of data and/or commands may be made by keyboard, pointing devices such as a mouse or trackball, touchpad, microphone, joystick, touch screen, or other input devices as one skilled in the art will appreciate. Processing of data by way of computer instruction may be locally or remotely, on a single unit or multiple units, in whole or in part, utilizing any form of network as necessary. Verification of data, instruction, commands, communications, and output, among others, may be made by way of portable storage device (such as a portable hard drive, disk, or other type of memory), visual display unit, printer, speaker or any other type of output device as those skilled in the art will appreciate, including those incorporating haptic technologies. Input, processing and output may occur on a single physical piece of equipment or at a single physical location or may be at multiple locations or on multiple physical pieces of equipment. It should be appreciated that any number of computing devices, arranged in a variety of manners, resources, architectures and configurations (e.g., cluster computing, virtual computing, cloud computing) can be used without departing from the spirit and scope of the invention).

In some aspects of the invention, data is input to the Standard of (K)are element 1000 regarding employee 100. It should be understood that element 100 may refer to participants, employees or others similarly situated. Such data 100 may be directly input individually by separate participants or by others on their behalf. In some aspects of the invention, participants will be employees of a certain employer, company or sponsor 200. It should be understood that element 200 may also include unions, associations, administrators of defined contribution plans, plan sponsors, or other groups of participants. Such data 200 may be directly input by the company, their representatives or by others on their behalf. Data may also be provided to the Standard of (K)are element 1000 regarding a plan, default plan, standard plan, or set of plans, more broadly considered financial vehicles, by the advisor, its representatives or others on its behalf, in some aspects of the invention 300. Third-party data, in some aspects of the invention, may also be input or automatically entered without further instruction to the Standard of (K)are element 1000, which may include government data, other third-party data, or other information distinct or partially distinct from element 100, 200, by way of the advisor 300 or sponsor 200.

As will be appreciated by those skilled in the art, data or information utilized by the Standard of (K)are element 1000, including but not limited to those identified as element 100, 200, 300, may be input, accessed, delivered, collected, deposited or obtained and used in any fashion whereby the data or information is made available for utilization, and need not necessarily be stored in any manner or stored in data storage device incorporated by the Standard of (K)are element 1000.

One or more outputs 500 or functions are executed by the Standard of (K)are element 1000, including but not limited to in some aspects of the invention to participant and/or employer service items, notifications performance analysis, data collection and risk mitigation compliance.

FIG. 1 also may illustrate, in some aspects of the invention, the collection of data, user, participant, employer, administrator, advisor, client, sponsor, fiduciary and others, options available, options selected, contemporaneous output and future outcome projections. In some aspects of the invention, FIG. 1 illustrates the collection of invention support, development and improvement data. In some aspects of the invention, FIG. 1 illustrates the collection of data from financial advisors, interaction with participants, employer, administrator, advisor, client, sponsor, fiduciary and others. In some aspects of the invention, this data collection maybe output so as to provide data, information and such support for mitigating risk, supporting claim defense, and in other such contexts. In some aspects of the invention, collection of data, including in those manners illustrated above as well as others, will provide information utilized by financial advisors, plan administrators, fiduciaries, as well as others, to provide opportunity for guidance, education, consistent financial advice, assistance and other such information familiar to those in the art. Data, information, contemporaneous options, choices, selections, projections, expectations, and other collected data are stored in a database, drive, memory or other such accessible format familiar to those in the art.

Other forms, functions and types of output are also anticipated by the invention not illustrated here.

In some aspects of the invention, the Standard of (K)are element 1000 utilizes the inputs and illustrates the individual participant's performance toward goals or targets. In other aspects of the invention, the Standard of (K)are element 1000 utilizes the inputs, evaluates and illustrates the group of participant's performance toward goals or targets. Both individual participants, groups of participants, employers, as well as others may also receive information and service items, notifications as outputs determined by Standard of (K)are element 1000 based upon information utilized from elements 100, 200, 300 or the like, in some aspects of the invention. Such information and notification can include, among others, initial enrollment service items, notifications changes to inputs (e.g. company financial match rates), reminders and privacy notifications. In other aspects of the invention, professional advisory notes, employer notes, plan administrator notes, evidence of educational materials, discussions, among others may be input into the Standard of (K)are element 1000 and utilized for example for retrieval at a later point in time, as initiating a participant service items, notification or other purpose.

In other aspects of the invention, participant data is collected and stored repeatedly so as to create a history of participant data. In other aspects of the invention, participant data is collected and stored upon any modification or change by an individual participant. In some aspects of the invention data is also collected and stored regarding sponsor 200 inputs, plan inputs, third-party inputs, or the like at intervals and at any change or modification so as to create a history of data. In other aspects of the invention, illustrations of individual participant's performance or groups of participants performance toward goals or targets is collected and stored so as to create a history of performance outputs. In yet other aspects of the invention, service items, notifications are collected and stored so as to create a history of notifications. In some aspects of the invention individual employees 100, sponsors 200, advisors 300, among others, may request information or prompt certain performance outputs from the Standard of (K)are element 1000, and the initiation and output and/or information is collected and stored so as to create a history of such acts and outputs. In other aspects of the invention, historical data such as from elements 100, 200, 300, service items, notifications outputs, and including but not limited to available options presented to users of Standard of (K)are 1000 and those known to be available but not presented may be compiled and presented and/or output in various combinations and formats 500, so as to be utilized for various needs comprising compliance, proof of service items, notifications proof of fiduciary duty activities, performance of fiduciary duties, participant opportunity and selection, advisory notes, educational notifications.

In some aspects of the invention, participant data 100 comprising name, age, date of birth, familial situation, gender, ethnicity or race may be collected. In other aspects of the invention, employee data 100 may also include a retirement date or goal date, whether performance output and evaluation 500 should be considered to the date of retirement or through the date of retirement.

In other aspects of the invention, income and/or assets external to the fiduciary vehicle(s) within the scope of fiduciary duty by the plan sponsor or administrator are identified and information collected regarding such external assets comprising real property, 401K, mutual funds, certificates of deposits, stocks, bonds, secured instruments, securities, index funds, equities, child support, alimony, and the like. Such information is input to the Standard of (K)are element 1000 and included as performance output and evaluation 500, in some aspects of the invention. Such information may also lead to educational opportunities output 500. Such information is collected and stored for use in the opportunity for consistent financial service and guidance among professionals and over time, in some aspects of the invention.

In yet other aspects of the invention, payments, debts and/or other financial outlays or obligations external to the fiduciary vehicle(s) within the scope of fiduciary duty by the plan sponsor or administrator are identified and information collected regarding such external outlays or obligations comprising medical payments, debt, medical conditions, alimony, child support, loans, mortgages, general expenditure patterns, and the like. Such information is input to the Standard of (K)are element 1000 and included as performance output and evaluation 500, in some aspects of the invention. Such information may also lead to educational opportunities output 500. Such information is collected and stored for use in the opportunity for consistent financial service and guidance among professionals and over time, in some aspects of the invention.

In yet other aspects of the invention, participant's individual risk tolerance is determined by use of tools such as a financial risk calculator or assessment. Financial risk tolerance calculators are known and may range from determination of ratings (for example comprising conservative, moderately conservative, moderate, moderately aggressive or aggressive) to more advanced versions (such as described in U.S. Pat. No. 8,224,732, issued to Mahoney, Jul. 17, 2012). The outcome of the use of the financial risk calculator is input into the Standard of (K)are element 1000 and is incorporated into the determination of the appropriateness of plan financial vehicle in order to meet fiduciary duties to the participants. In some aspects of the invention, the risk tolerance may be explicitly set. In some aspects of the invention, the outcome of the use of the financial risk calculator is input into the Standard of (K)are element 1000 may guide the selection of a specific financial vehicle, among many, for application in performance analysis and evaluation. Multiple potential outcomes of the use of the financial risk calculator may also be employed in presenting variations of performance analysis and evaluation. Such use, method and outcome of the use of the financial risk calculator associated with participant data and projections arc also collected for later use in risk mitigation, for example. Multiple uses of the financial risk calculator over time and/or after education, financial guidance, professional assistance, among other additions, are possible and collected for later use in risk mitigation by element, for use in guiding consistent financial service and guidance among professionals and over time, in some aspects of the invention. Variations of performance analysis and evaluation, as incorporating outcomes of use of the financial risk calculator may also be collected for later use in risk mitigation by element, for example.

In some aspects of the invention, additional data associated with participants is incorporated into a participant profile. Such participant profile is built of data from elements 100, 200, 300, among others. Participant address, communication preferences, notes, requests, may also be comprise the participant profile. Participant profiles, in some aspects of the invention, may also be comprised of identification of retirement readiness, goal achievement, reporting, service items, notification, messages, follow-up requirements, physical location, mailing address, action reminders. Such information may also be utilized by element 1000 in providing notices 500 to the participant for example, in some aspects of the invention. Third-party data, which may associated with the participant may also be incorporated with participant profile, in some aspects of the invention. Participant profile data may be collected and stored repeatedly so as to create a history of participant data 500, in some aspects of the invention. In other aspects of the invention, participant profile data is collected and stored upon any modification or change by an individual participant or at intervals so as to create a history of data 500.

In other aspects of the invention, the contribution rate is input into the Standard of (K)are element 1000 and included in the output of a performance analysis and evaluation 500. The default contribution rate, for example as set by the plan sponsor, and/or any participant directed contribution rate, matching contribution funds or profit sharing, vesting, for example, are contemplated as incorporated as contribution rate. In some aspects of the invention, company contribution data may be comprised of match percent, match frequency, profit sharing, amount, percentage. Eligibility data may also be present in some aspects of the invention comprised of age, years of service, immediate plan entry, monthly plan entry, quarterly plan entry, semi-annual plan entry, enrollment method, whether enrollment is automatic, as well as levels if any of low balance force out. Data regarding the options and possible range of selections of the contribution rate are collected for later use in risk mitigation, for example. Ranges of possibilities based upon the contribution rate may also be presented as a performance analysis and evaluation 1000. Variations of performance analysis and evaluation 1000, as incorporating outcomes of contribution rate may also be collected for later use in risk mitigation by element 500, for example.

In some aspects of the invention, performance output 500 is presented with the addition of information 100, 200, 300, among others. The performance outputs 500 and range of possible performance outputs 500 may also be collected for later use in risk mitigation by element 1000, among other uses, comprising historical illustrations for participants, administrators, sponsors, and external evaluators, for example.

In some aspects of the invention, analysis and output 500 will indicate whether the individual participant will meet the default or stated target goal. In other aspects of the invention a Plan Health Report is output 500 indicating whether participants en masse (or subset) will achieve the default, explicitly set, or stated goals. In other aspects of the invention, participant characteristics are mined from the participant profiles or enhanced participant profiles and output for consideration. These participant characteristics may be comprised of data indicating a need for financial education, medical needs, adjusting medical insurance plan opportunities for employees, adjusting workers compensation coverage, or the need for employee retention due to high employee turnover, among other aspects. In yet another aspect of the invention, the individual financial vehicles are reviewed as to their performance, and graded as part of an output, this may be comprised of an investment score card. The grading is a valuable tool in determining whether a specific financial vehicle has been selected as an appropriate QDIA or is otherwise an appropriate selection for accomplishing the duties of the fiduciary at the participant level.

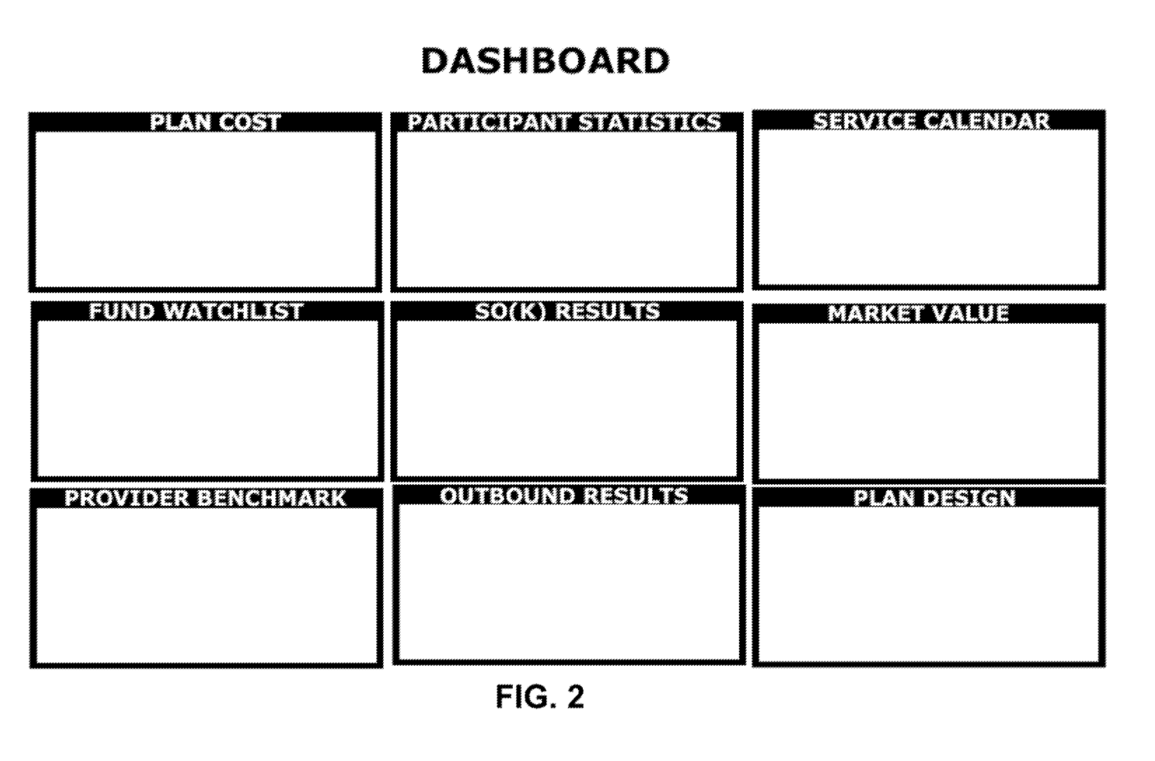

In some aspects of the invention, tools or functions will permit the presentation of a dashboard FIG. 2 identifying recent update information among participants, sponsors, advisors and third-party information as it is applied to the invention. Such dashboard FIG. 2 may also be comprised of presenting actions assigned in calendar sequence, as well as identified high value participants that meet key opportunity criteria previously set for use by the invention, in some aspects of the invention. Such dashboard FIG. 2 may also be comprised of numerous output options comprising summaries of plan costs, participant statistics, service calendar, fund watch list, market value, provider benchmark, outbound results, plan design statistics, retirement readiness, goal achievement progress, educational opportunities taken or refused, additional participant data required, SOK or SO(K) results among others. The invention, in some aspects, will permit the search and selection of individual participants by name or other criteria, which may present in the participant profile. Such criteria, in some aspects of the invention, may be comprised of flags identifying individual participants as high asset, high net worth, concierge service or committee members, contact details, company associations and links to the company, profile of the individual participant, and home address of the participant. In some aspects of the invention, participant data comprised of first, middle, and last name, identification number, salutation, date of birth, preferred contact method, work email address, personal email address, home phone, mobile phone, work phone, mailing address, facsimile number, password, login and other participant data may be identified and collected. In some aspects of the invention, notes or miscellaneous fields may be created to store data associated with individual participants, as well as participant risk profiles, which may be comprised of risk ratings, dates of risk rating, history of prior risk ratings. Individual participant retirement calculator output, functions and inputs may exist in some aspects of the invention, as well as a Standard of (K)are rating, date, history of ratings and history of retirement planning outcomes. Participant activities, meetings, notes, classification of educational opportunities as well as educational groupings may also be present in some aspects of the invention. In some aspects of the invention meeting data may be comprised of resulting investment allocation changes, contribution changes, requests and fulfillment of beneficiary forms, rollover forms, enrollment forms, fund menus or other requests among others.

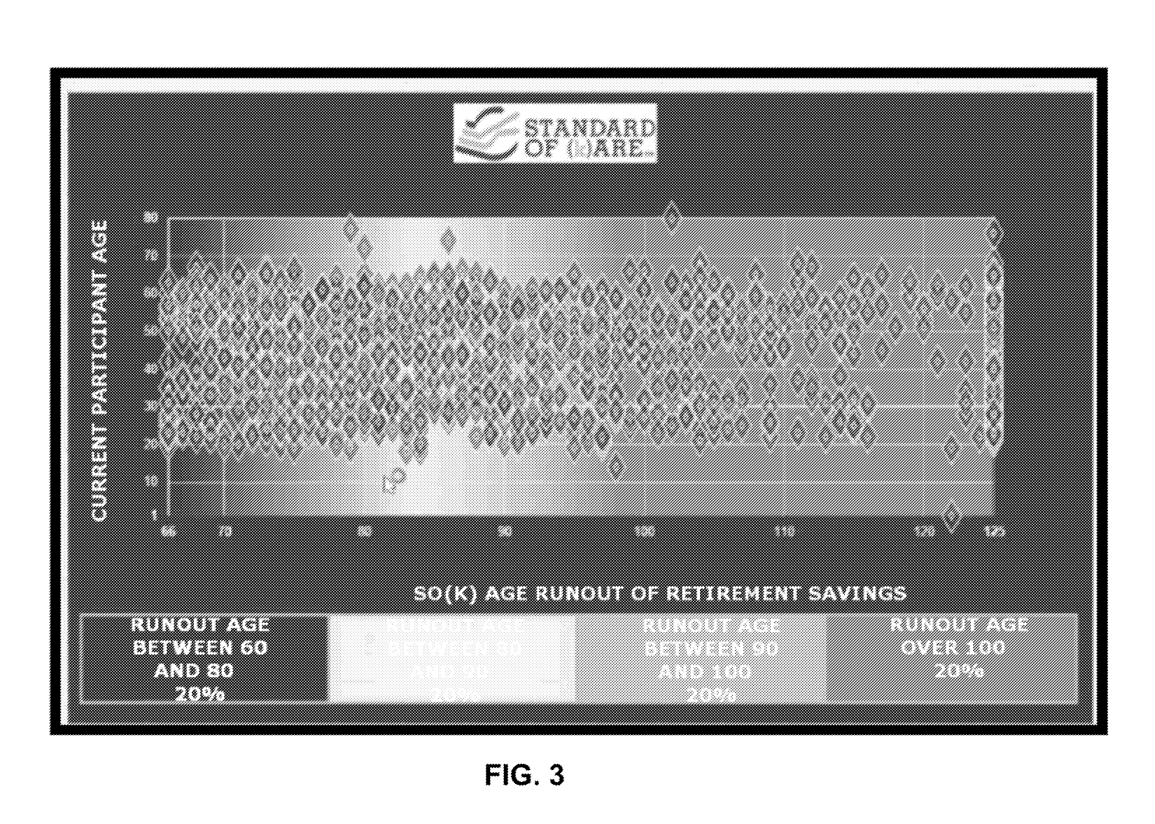

In some aspects of the invention, tools or functions will permit the presentation of visual display of participant age and age runout of retirement savings FIG. 3. Such visual display would permit the summary display of a single participant or groups of participants' retirement readiness and may assist in determination of the fiduciary compliance, appropriateness of financial vehicles, participants contribution rates, personal history of participants, documentation, among other aspects of the invention.

In some aspects of the invention, tools or functions will permit the search and selection of individual companies based upon criteria identified in a company profile. Company profiles may be comprised of in some aspects of the invention, general information, industry type, tax ID, website address, account representative, telephone, facsimile, email, mailing address and physical locations. Some aspects of the invention may also have associated with individual companies board room services comprising annual and quarterly plan reviews onsite, via phone or conference, and break room services contracted comprising educational events via onsite, telephone, or conference, as well as dates, educators, supplies, educator instructions and criteria, and additional notes, company contacts, company addresses, participants identified and associated with individual companies, and output of year to date results for an individual company. Contact data may be comprised of primary contacts, human resource contacts, signatories, decision makers, scheduling, payroll, investment committee members in some aspects of the invention. Company data may be comprised of include, in some aspects of the invention, company name, account representatives, account managers, industry type, phone, facsimile, website, tax identification number among other data. In some aspects of the invention, an individual company may have associated participant data or statistics comprised of eligible and active participants, participation rates, highly compensated employee deferral rates, non-highly compensated employee deferral rates, automatic enrollment data, automatic enrollment determined from plan designs, automatic enrollment determined from industry benchmarks, as well as ROTH deferrals determined from plan designs, ROTH deferrals determined from industry benchmarks, those ROTH deferrals associated with plans named for the chief legislative sponsor, Senator William Roth of Delaware. Plan design data, in some aspects of the invention may be comprised of legal plan names, plan type, plan established date, provider, product, as well as plan number. Plan data may also be comprised of in some aspects of the invention relationship managers, account managers, plan compliance and testing, third party agreements. In yet other aspects of the invention, plan assets, documents, plan designs, plan contacts be comprised of investments, education, investment committee, service calendar, participant statistics, plan design may be identified, input and utilized. In some aspects of the invention plan investment data may be comprised of default funds, model portfolios, automatic increases and the type or factors, whether ROTH plans, in plan ROTH conversions, contribution limits and changes to contribution methods, among others. Default data may also be comprised of normal retirement age plan design defaults, early retirement age plan design defaults, model portfolios in some aspects of the invention. Other data may include vesting, vesting scheduled, loans, loan rates, loan minimums, loan hardships, fees such as advisor fees among others, in some aspects of the invention. In other aspects of the invention, a company report card or investment score card may be determined indicating the success of the participants in the plan or the success of the fiduciary in meeting its duties. In some aspects of the invention, documents data may be comprised of name, type such as for example adoption agreement, 408b2, IPS, among other types, format such as PDF, MS Word, or others, and effective and expiration dates, among other data.

Additional features of the invention, in some aspects, may be comprised of a message center which may provide for the ability to send messages, service items, notifications or other information, to manage templates for those messages and to track, collect and store such information. Message data may be comprised of name, nickname, subject, body, date, delivery status, failure service items, notification, message read status comprised of date, opened, interne protocol address of recipient upon reading message, among other data. In some aspects of the invention, administrative tools comprised of managing users, participants, sponsors, updating, adding and eliminating users may be present. In other aspects of the invention, general data may be input via data management tools be comprised of groups of profiles or data imported or output, bulk load of participants, participant data or participant profiles, mortality rates, fee benchmarks and system settings. In some aspects of the invention, investment fund data may be collected be comprised of fund name, fund company, lists of fund companies, stock ticker identification, investment type such as cash/fixed income, domestic equity, international equity, alternative. In other aspects of the invention investment fund data may be comprised of revenue sharing, active dates for account, inactive dates for account, balance data, expense ratio, net expense, current assets, as well as other data.

In yet another aspect of the invention, a plan sponsor center may be provided comprising a display of the current status of the Standard of (K)are system, access to employees by way of searches for employees or participants, the ability to create new participants in the system with corresponding queued events and tracked data, as well as the ability to update participant data such as contact information, address and employment status or termination. Participant data may also be comprised of in some aspects of the invention contact information, company identification, date of hire, eligibility rate, termination rate, active status, eligible status, termed status, outbound status, notes, home address, risk profiles. Risk profiles may be comprised of in some aspects of the invention survey identifiers, survey versions, date of create, date of update, individual survey questions, question identifier, question texts, survey response, survey answer, identifier of response, identifier of answer, response text, answer text, response value, answer value, risk rating, risk date, rating version, rating version question identifier, risk rating version question response, rating version answer. In other aspects of the invention, participant retirement profiles may be comprised of data including instance dates, income information, salary information, expected salary raise information, inflation rate assumptions, retirement goal age, retirement social security collection age, desired retirement income, retirement balance of 401K and outside assets as well as contribution percent and contribution goals of those 401K and outside assets. Retirement evaluations may also be present in some aspects of the invention, comprising evaluation date, projected retirement run out current, projected retirement run out goal, projected monthly income, projected company contribution, projected participant contribution, projected retirement savings at retirement. In some aspects of the invention, identification of investment committee members may be by factors comprising profile, flag, data or group. In other aspects, system service requests, and service tracking may be possible with activity logs for corrections, improvements, alternations or other changes to the system. In some aspects of the invention system users may be identified and data collected comprising such as participant data identified above, as well as passwords, permissions, permission roles, login, user status, identification as internal or external users. Account access data may be comprised of login, notes, instructions, reset procedures and functions, defaults, participant information, in some aspects of the invention. In some aspects of the invention, data may be comprised of income tax information, income tax tables, mortality information, mortality tables, participation rates, participation rates segmented by industry, participation rates segmented by company size, fee benchmarks, fee benchmarks segmented by criteria, task identification, task titles, task descriptions, task creation dates, task creation authors, task due dates, task assignments, task status, task relationship with company, participant, contact, for example, and note identifiers, note create date, note creation author, note contents, note visibility, and note relationship with company, participant, contact, for example.

Advantages and benefits of the invention, in addition to those above, will be apparent to those persons of ordinary skill in the art. Updates to and output of options, selections, data and participants, for example, may be displayed individually or displayed alongside one another, as would be apparent to one skilled in the art, in some aspects of the invention. Presentation of choices, input collection, options, information, data, contemporaneous, historical and projected performance, may be conducted serially, parallel, simultaneously or automatically based upon other information, in some aspects of the invention, as would be apparent to one skilled in the art. Upon consideration of the specification and practice of the invention, other embodiments and uses of the invention will be apparent to those persons of ordinary skill in the art. The examples above and specification are considered only exemplary, and the following claims will cover other such embodiments or modifications as will fall within the true scope of the invention.

What is claimed is:

1. A computer-implemented method of evaluating fiduciary compliance, the method comprising:
At least one processor and at least one storage medium;
Receiving at a computer data regarding participant information;
Receiving at a computer data regarding sponsor or company information;
Receiving at a computer data comprising possible financial vehicles, pensions, assets, income streams, or funds;
Analyzing the allocation among financial vehicles, pensions, assets, income streams, or funds based upon participant data;
Determining the expected future performance of the participants' financial vehicles, pensions, assets, income streams, or funds;
Outputting via a visual representation or other medium the information collected regarding the participant, financial vehicles, pensions, assets, income streams, or funds, expected future performance of participants' financial vehicles, pensions, assets, income streams, or funds;
Collecting and storing participant information, possible financial vehicles, pensions, assets, income streams, or funds, expected future performance of the participants' financial vehicles, pensions, assets, income streams, or funds, outputs;
Permitting the modification of participant information, financial vehicles, pensions, assets, income streams, or fund selection, and output, collecting and storing that information;
Wherein the expected future performance of the participants' financial vehicles, pensions, assets, income streams, or funds and participant information document activities in furtherance of fiduciary duties of those comprising any investor, participant, plan sponsor, fiduciary, administrator.

2. The method of claim 1, wherein the participant information, possible financial vehicles, pensions, assets, income streams, or funds, expected future performance of the participants' financial vehicles, pensions, assets, income streams, or funds, outputs is documented, tracked and stored in the system for later recall.

3. The method of claim 1, wherein factors comprising opportunities, service items, notification, assumptions, documentation, selection, monitoring, decision making, requirements and regulations regarding fiduciary safe harbor provisions are compared against outputs comprising the allocation among financial vehicles, pensions, assets, income streams or funds, the expected future performance.

4. The method of claim 3, wherein the factors and outputs are documented, tracked and stored in the system for later recall.

5. The method of claim 1, wherein activities comprising participants, investment managers, plan trustees, plan sponsors, committees of employees, registered investment companies, employers, unions, associations, administrators, are documented, tracked and stored in the system for later recall for access by those comprising advisors, employers, unions, associations, administrators, plan sponsors.

6. The method of claim 1, wherein factors comprising opportunities, service items, notification, assumptions, documentation, selection, monitoring, decision making, requirements and regulations regarding duty and notification provisions are identified, and compliance facilitated and documented, tracked and stored in the system for later recall.

7. The method of claim 1, wherein the participant data includes device comprising a risk profile, risk tolerance questionnaire or risk tolerance calculator.

8. The method of claim 1, wherein the participant data includes external data comprising information regarding anticipated social security, government assistance, mortality data, inflation rate, alimony, income streams, housing assets, medical factors, personal history, budget worksheet items.

9. The method of claim 1, wherein the individual participant data is combined with other participant data comprising age groups, gender, employer, employment type, earning groups.

10. The method of claim 1, wherein individual participant data is comprised of variable participant contribution rates, deferral amounts, goal amount, goal date, retirement date, glide path, employment termination.

11. The method of claim 1, wherein data comprising participant information, sponsor, company information, possible financial vehicles, pensions, assets, income streams, funds, expected future performance of participants' financial vehicles, pensions, assets, income streams, or funds, outcome, retirement savings age runout, opportunities, service items, notification, assumptions, fees, costs, past performance, future anticipated performance are able to be manipulated comprising of individually identification, grouped, ranked, categorized.

12. The method of claim 1, wherein the participant output is categorized into a retirement readiness score or score card.

13. The method of claim 1, wherein participant output is comprised of a retirement profile, outcome, retirement savings age runout.

14. The method of claim 3, wherein factors comprising opportunities, service items, notification, assumptions, documentation, selection, monitoring, decision making, requirements and regulations regarding duty, service and notification provisions are identified, and compliance facilitated and documented, tracked and stored in the system for later recall.

15. The method of claim 14, wherein compliance with factors comprising use of the system, fiduciary duties, service items, notifications documentation is categorized into a score or Plan Health Report or Standard of (K)are or SOK or SO(K) rating.

16. The method of claim 1, wherein financial vehicles, comprising pensions, assets, income streams, or funds, are evaluated by factors comprising, fees, costs, past performance, future anticipated performance.

17. The method of claim 1, wherein the expected future performance of the participants' financial vehicles, pensions, assets, income streams, or funds and participant information determine whether educational materials are suggested as appropriate for review by any participant, sponsor or other user.

18. The method of claim 17, wherein the determination of educational materials for review comprising the type, materials, audience, use are documented, tracked and stored in the system for later recall.

19. A computer system for processing data related to evaluating fiduciary compliance, comprising:
At least one processor and at least one storage medium;
Receiving at a computer data regarding participant information;
Receiving at a computer data regarding sponsor or company information;
Receiving at a computer data comprising possible financial vehicles, pensions, assets, income streams, or funds;
Analyzing by the computer the allocation among financial vehicles, pensions, assets, income streams, or funds based upon participant data;
Determining by the computer the expected future performance of the participants' financial vehicles, pensions, assets, income streams, or funds;
Outputting by the computer via a visual representation or other medium the information collected regarding the participant, financial vehicles, pensions, assets, income streams, or funds, expected future performance of participants' financial vehicles, pensions, assets, income streams, or funds;
Collecting and storing by the computer participant information, possible financial vehicles, pensions, assets, income streams, or funds, expected future performance of the participants' financial vehicles, pensions, assets, income streams, or funds, outputs;
Permitting by the computer the modification of participant information, financial vehicles, pensions, assets, income streams, or fund selection, and output, collecting and storing that information;
Wherein the expected future performance of the participants' financial vehicles, pensions, assets, income streams, or funds and participant information document activities by the computer in furtherance of fiduciary duties of those comprising any investor, participant, plan sponsor, fiduciary, administrator.

20. A non-transitory computer-readable medium, the medium having executable instructions stored thereon for processing data related to evaluating fiduciary compliance, comprising:
At least one processor and at least one storage medium;
Receiving at a computer data regarding participant information;
Receiving at a computer data regarding sponsor or company information;
Receiving at a computer data comprising possible financial vehicles, pensions, assets, income streams, or funds;
Analyzing by the computer the allocation among financial vehicles, pensions, assets, income streams, or funds based upon participant data;
Determining by the computer the expected future performance of the participants' financial vehicles, pensions, assets, income streams, or funds;
Outputting by the computer via a visual representation or other medium the information collected regarding the participant, financial vehicles, pensions, assets, income streams, or funds, expected future performance of participants' financial vehicles, pensions, assets, income streams, or funds;
Collecting and storing by the computer participant information, possible financial vehicles, pensions, assets, income streams, or funds, expected future performance of the participants' financial vehicles, pensions, assets, income streams, or funds, outputs;
Permitting by the computer the modification of participant information, financial vehicles, pensions, assets, income streams, or fund selection, and output, collecting and storing that information;
Wherein the expected future performance of the participants' financial vehicles, pensions, assets, income streams, or funds and participant information document activities by the computer in furtherance of fiduciary duties of those comprising any investor, participant, plan sponsor, fiduciary, administrator.
